(19) United States
(12) Patent Application Publication
(10) Pub. No.: US 2025/0026915 A1
(43) Pub. Date: Jan. 23, 2025

(54) VIBRATION ISOLATION RUBBER COMPOSITION AND VIBRATION ISOLATION RUBBER MEMBER

(71) Applicant: Sumitomo Riko Company Limited, Aichi (JP)

(72) Inventors: Yuto Watanabe, Aichi (JP); Seiji Kasai, Aichi (JP); Toyohisa Tohyama, Aichi (JP)

(73) Assignee: Sumitomo Riko Company Limited, Aichi (JP)

(21) Appl. No.: 18/907,595

(22) Filed: Oct. 7, 2024

Related U.S. Application Data
(63) Continuation of application No. PCT/JP2023/023306, filed on Jun. 23, 2023.

(30) Foreign Application Priority Data
Jun. 30, 2022 (JP) 2022-106077

(51) Int. Cl. C08K 5/3415; C08K 3/013; C08K 3/04; C08K 3/36; C08K 5/47; C08K 11/00

(52) U.S. Cl. CPC C08K 5/3415; C08K 3/013; C08K 3/04; C08K 3/36; C08K 5/47; C08K 11/00; C08K 2201/006

(57) ABSTRACT

Provided are a vibration isolation rubber composition and a vibration isolation rubber member, which can suppress a decrease in durability while improving resistance to vulcanization reversion. The vibration isolation rubber composition contains components (A) to (E), and is characterized in that relative to 100 parts by mass of component (A), the content of component (B) is 0.6-5.5 parts by mass, the content of component (C) is 0.45-3.5 parts by mass, the content of component (D) is 0.25-5.5 parts by mass, and the mass ratio [(C)/(D)] of component (C) relative to component (D) is 0.15-5.0. (A) A diene-based rubber. (B) A bismaleimide compound. (C) A sulfenamide-based vulcanization accelerator. (D) A sulfur-based vulcanizing agent. (E) An inorganic filler.

### CROSS-REFERENCE TO RELATED APPLICATION

The present application is a continuation of PCT/JP2023/023306, filed on Jun. 23, 2023, and is related to and claims priority from Japanese Patent Application No. 2022-106077 filed on Jun. 30, 2022. The entire contents of the aforementioned application are hereby incorporated by reference herein.

### TECHNICAL FIELD

The disclosure relates to a vibration isolation rubber composition and a vibration isolation rubber member used for vibration isolation in vehicles such as automobiles and trains.

### RELATED ART

When a vibration isolation rubber composition containing a diene-based rubber such as a natural rubber is over-vulcanized, vulcanization reversion occurs. Vulcanization reversion is a phenomenon that polysulfide bonds and disulfide bonds change to monosulfide bonds, and the monosulfide bonds undergo a cleavage reaction accompanied by formation of a thiophene ring, resulting in a decrease in vulcanization density, and there are concerns about the deterioration of various properties.

Several techniques have been proposed for improving the resistance to vulcanization reversion of such a vibration isolation rubber composition. For example, it has been proposed to use 1,3-bis(citraconimidomethyl)benzene, 1,6-sodium hexamethylenedithiosulfate (see, for example, Patent Document 1 (Japanese Patent Application Laid-Open No. 2007-146035)), or use zinc monomethacrylate (ZMMA) or the like, as an anti-vulcanization reversion agent added to the vibration isolation rubber composition.

However, in vibration isolation rubber compositions, research has not yet progressed sufficiently, which focuses not only on improving the resistance to vulcanization reversion but also on achieving a high degree of both resistance to vulcanization reversion and durability.

The disclosure provides a vibration isolation rubber composition that can suppress a decrease in durability while improving resistance to vulcanization reversion.

That is, in the process of examining various techniques for improving the resistance to vulcanization reversion of vibration isolation rubber compositions, the inventors focused on the fact that while the techniques of using the vulcanization reversion inhibitors as described above improve resistance to vulcanization reversion, durability may decrease due to the roughening and densification of the crosslinked structure.

As a result of further research from the viewpoint of achieving both high resistance to vulcanization reversion and high durability, the inventors unexpectedly found that it is possible to provide a vibration isolation rubber composition that can suppress a decrease in durability while improving resistance to vulcanization reversion by controlling the respective contents of a bismaleimide compound, a sulfenamide-based vulcanization accelerator, and a sulfur-based vulcanizing agent within specific ranges, and controlling the mass ratio of the sulfenamide-based vulcanization accelerator and the sulfur-based vulcanizing agent within a specific range.

### SUMMARY

That is, the gist of the disclosure lies in the following [1] to [13].
[1] A vibration isolation rubber composition, containing the following components (A) to (E) and being characterized in that, relative to 100 parts by mass of the component (A), a content of the component (B) is 0.6 to 5.5 parts by mass, a content of the component (C) is 0.45 to 3.5 parts by mass, a content of the component (D) is 0.25 to 5.5 parts by mass, and a mass ratio [(C)/(D)] of the component (C) to the component (D) is 0.15 to 5.0.
(A) diene-based rubber
(B) bismaleimide compound
(C) sulfenamide-based vulcanization accelerator
(D) sulfur-based vulcanizing agent
(E) inorganic filler
[2] The vibration isolation rubber composition according to [1], in which the (D) sulfur-based vulcanizing agent has a content of 0.5 to 5.5 parts by mass.
[3] The vibration isolation rubber composition according to [1] or [2], in which the mass ratio [(C)/(D)] of the (C) sulfenamide-based vulcanization accelerator to the (D) sulfur-based vulcanizing agent is 0.15 to 1.35.
[4] The vibration isolation rubber composition according to any one of [1] to [3], in which a mass ratio [(B)/(C)] of the (B) bismaleimide compound to the (C) sulfenamide-based vulcanization accelerator is 0.4 to 5.5.
[5] The vibration isolation rubber composition according to any one of [1] to [4], containing N,N′-m-phenylene bismaleimide as the (B) bismaleimide compound.
[6] The vibration isolation rubber composition according to any one of [1] to [5], containing at least one selected from a group consisting of N-cyclohexyl-2-benzothiazolyl sulfenamide and N-oxydiethylene-2-benzothiazolyl sulfenamide, as the (C) sulfenamide-based vulcanization accelerator.
[7] The vibration isolation rubber composition according to any one of [1] to [6], containing at least one selected from a group consisting of carbon black and silica, as the (E) inorganic filler.
[8] The vibration isolation rubber composition according to any one of [1] to [7], containing carbon black having a BET specific surface area of 10 to 150 m²/g, as the (E) inorganic filler.
[9] The vibration isolation rubber composition according to any one of [1] to [8], containing carbon black having an iodine adsorption amount of 10 to 150 mg/g, as the (E) inorganic filler.
[10] The vibration isolation rubber composition according to any one of [1] to [9], further containing a thiuram-based vulcanization accelerator.
[11] A vibration isolation rubber member, made of a vulcanizate of the vibration isolation rubber composition according to any one of [1] to [10].
[12] The vibration isolation rubber member according to [11], being a vibration isolation rubber member for a vehicle.
[13] The vibration isolation rubber member according to [12], being a vibration isolation rubber member for a component part of an engine mount, a stabilizer bush, or a suspension bush.

The disclosure can provide a vibration isolation rubber composition that can suppress a decrease in durability while improving resistance to vulcanization reversion.

### DESCRIPTION OF EMBODIMENTS

An embodiment of the disclosure will be described in detail. However, the disclosure is not limited to this embodiment.

The vibration isolation rubber composition according to one embodiment of the disclosure (hereinafter, may be referred to as “this vibration isolation rubber composition”) is a vibration isolation rubber composition that contains components (A) to (E) and is characterized in that, relative to 100 parts by mass of component (A), the content of component (B) is 0.6 to 5.5 parts by mass, the content of component (C) is 0.45 to 3.5 parts by mass, the content of component
(D) is 0.25 to 5.5 parts by mass, and the mass ratio [(C)/(D)] of component (C) to component (D) is 0.15 to 5.0.
(A) a diene-based rubber
(B) a bismaleimide compound
(C) a sulfenamide-based vulcanization accelerator
(D) a sulfur-based vulcanizing agent
(E) an inorganic filler

In the disclosure, it is important to control the respective contents of (B) the bismaleimide compound, (C) the sulfenamide-based vulcanization accelerator, and (D) the sulfur-based vulcanizing agent in the vibration isolation rubber composition containing components (A) to (E) within specific ranges, and control the mass ratio of (C) the sulfenamide-based vulcanization accelerator to (D) the sulfur-based vulcanizing agent within a specific range. If these are not controlled within the specific ranges, it is not possible to suppress a decrease in durability while improving resistance to vulcanization reversion, and therefore the problems of the disclosure cannot be sufficiently solved.

The constituent raw materials of this vibration isolation rubber composition will be described in detail below.

### [(A) Diene-Based Rubber]

This vibration isolation rubber composition contains (A) the diene-based rubber as a rubber component. (A) The diene-based rubber includes, for example, a natural rubber (NR), a butadiene rubber (BR), a styrene-butadiene rubber (SBR), a chloroprene rubber (CR), an isoprene rubber (IR), an acrylonitrile-butadiene rubber (NBR), an ethylene-propylene-diene rubber (EPDM), a butyl rubber (IIR), a chloroprene rubber (CR), etc. These may be used alone or in combination of two or more. Among these, a natural rubber (NR) is preferred from the viewpoint of improving durability.

(A) The diene-based rubber used in this vibration isolation rubber composition is preferably a diene-based rubber containing a natural rubber (NR) as the main component. Here, the term “main component” means containing 50% by mass or more relative to the total amount (100% by mass) of (A) the diene-based rubber, preferably 60% by mass or more, more preferably 70% by mass or more, even more preferably 80% by mass or more, and particularly preferably 90 to 100% by mass.

Preferably this vibration isolation rubber composition does not substantially contain any rubber component other than (A) the diene-based rubber. For example, the content of a rubber component other than (A) the diene-based rubber is less than 1 part by mass relative to 100 parts by mass of (A) the diene-based rubber, preferably less than 0.1 part by mass, and more preferably 0 part by mass.

The content of (A) the diene-based rubber contained in this vibration isolation rubber composition is usually 45% by mass or more relative to the total amount (100% by mass) of this vibration isolation rubber composition, and preferably about 45 to 70% by mass or 50 to 65% by mass.

[(B) Bismaleimide compound]

This vibration isolation rubber composition contains a specific amount of (B) the bismaleimide compound. (B) The bismaleimide compound includes, for example, N,N′-m-phenylene bismaleimide, N,N′-o-phenylene bismaleimide, N,N′-p-phenylene bismaleimide, N,N′-(4,4′-diphenylmethane) bismaleimide, 2,2-bis[4-(4-maleimidophenoxy)phenyl]propane, bis(3-ethyl-5-methyl-4-maleimidophenyl]methane, etc. These may be used alone or in combination of two or more. Among these, N,N′-m-phenylene bismaleimide is preferred from the viewpoint of achieving both resistance to vulcanization reversion and durability.

From the viewpoint of achieving both resistance to vulcanization reversion and durability, it is important that the content of (B) the bismaleimide compound is 0.6 to 5.5 parts by mass relative to 100 parts by mass of (A) the diene-based rubber. Outside this range, durability tends to decrease, making it difficult to achieve both resistance to vulcanization reversion and durability.

From the viewpoint of further improving resistance to vulcanization reversion and durability, the content of (B) the bismaleimide compound is preferably 0.7 to 5.2 parts by mass.

### [(C) Sulfenamide-Based Vulcanization Accelerator]

This vibration isolation rubber composition contains a specific amount of (C) the sulfenamide-based vulcanization accelerator. (C) The sulfenamide-based vulcanization accelerator includes, for example, N-oxydiethylene-2-benzothiazolylsulfenamide (NOBS), N-cyclohexyl-2-benzothiazolylsulfenamide (CBS), N-t-butyl-2-benzothiazoylsulfenamide (BBS), N,N′-dicyclohexyl-2-benzothiazoylsulfenamide, etc. These may be used alone or in combination of two or more. Among these, from the viewpoint of achieving both resistance to vulcanization reversion and durability, N-cyclohexyl-2-benzothiazolylsulfenamide (CBS) and N-oxydiethylene-2-benzothiazolylsulfenamide (NOBS) are preferred.

In addition, from the viewpoint of achieving both resistance to vulcanization reversion and durability and improving scorch resistance (storage stability), N-oxydiethylene-2-benzothiazolylsulfenamide (NOBS) is preferred.

From the viewpoint of achieving both resistance to vulcanization reversion and durability, it is important that the content of (C) the sulfenamide-based vulcanization accelerator is 0.45 to 3.5 parts by mass relative to 100 parts by mass of (A) the diene-based rubber. Outside this range, durability tends to decrease, making it difficult to achieve both resistance to vulcanization reversion and durability.

From the viewpoint of further improving resistance to vulcanization reversion and durability, the content of (C) the sulfenamide-based vulcanization accelerator is preferably 0.45 to 3.2 parts by mass.

The mass ratio [(B)/(C)] of (B) the bismaleimide compound to (C) the sulfenamide-based vulcanization accelerator is preferably 0.4 to 8.0 from the viewpoint of achieving both resistance to vulcanization reversion and durability, more preferably 0.4 to 5.5, and even more preferably 0.5 to 2.0.

### [(D) Sulfur-Based Vulcanizing Agent]

This vibration isolation rubber composition contains a specific amount of (D) the sulfur-based vulcanizing agent. (D) The sulfur-based vulcanizing agent includes, for example, sulfur (powdered sulfur, precipitated sulfur, insoluble sulfur), a sulfur-containing compound such as alkylphenol disulfide. These may be used alone or in combination of two or more.

From the viewpoint of achieving both resistance to vulcanization reversion and durability, it is important that the content of (D) the sulfur-based vulcanizing agent is 0.25 to 5.5 parts by mass relative to 100 parts by mass of (A) the diene-based rubber. Outside this range, resistance to vulcanization reversion and durability tend to decrease, making it difficult to achieve both resistance to vulcanization reversion and durability.

From the viewpoint of further improving resistance to vulcanization reversion and durability, the content of (D) the sulfur-based vulcanizing agent is preferably 0.5 to 5.5 parts by mass.

It is important that the mass ratio [(C)/(D)] of (C) the sulfenamide-based vulcanization accelerator to (D) the sulfur-based vulcanizing agent is 0.15 to 5.0 from the viewpoint of achieving both resistance to vulcanization reversion and durability. Outside this range, durability tends to decrease, making it difficult to achieve both resistance to vulcanization reversion and durability.

From the viewpoint of further improving resistance to vulcanization reversion and durability, the mass ratio [(C)/(D)] is preferably 0.15 to 2, and more preferably 0.15 to 1.35.

### [(E) Inorganic Filler]

This vibration isolation rubber composition contains (E) the inorganic filler. (E) The inorganic filler includes, for example, carbon black, silica, calcium carbonate, etc. These may be used alone or in combination of two or more. Among these, from the viewpoint of improving durability, carbon black and silica are preferred, and carbon black is more preferred.

Carbon black includes, for example, various grades of carbon black such as SAF grade, ISAF grade, HAF grade, MAF grade, FEF grade, GPF grade, SRF grade, FT grade, and MT grade. These may be used alone or in combination of two or more.

The BET specific surface area of carbon black is preferably 10 to 150 m²/g from the viewpoint of achieving both resistance to vulcanization reversion and durability, more preferably 15 to 100 m²/g, even more preferably 20 to 76 m²/g, and particularly preferably 25 to 65 m²/g.

The BET specific surface area of carbon black can, for example, be measured by a BET specific surface area measuring device (4232-II, manufactured by Microdata Corporation) using a mixed gas (N₂: 70%, He: 30%) as the adsorption gas after degassing the sample at 200° C. for 15 minutes.

From the viewpoint of achieving both resistance to vulcanization reversion and durability, the iodine adsorption amount of carbon black is preferably 10 to 150 mg/g, more preferably 10 to 75 mg/g, and even more preferably 20 to 65 mg/g. In addition, the DBP (dibutyl phthalate) absorption amount of carbon black is preferably 20 to 180 mL/100 g, and more preferably 20 to 150 mL/100 g.

The iodine adsorption amount of carbon black is a value measured in accordance with JIS K 6217-1 (Method A), and the DBP absorption amount of carbon black is a value measured in accordance with JIS K 6217-4.

Silica includes, for example, wet silica, dry silica, colloidal silica, etc. These may be used alone or in combination of two or more.

From the viewpoint of achieving both resistance to vulcanization reversion and durability, the BET specific surface area of silica is preferably 30 to 320 m²/g, and more preferably 50 to 230 m²/g.

The BET specific surface area of silica can, for example, be measured by a BET specific surface area measuring device (4232-II, manufactured by Microdata Corporation) using a mixed gas (N₂: 70%, He: 30%) as the adsorption gas after degassing the sample at 200° C. for 15 minutes.

From the viewpoint of achieving both resistance to vulcanization reversion and durability, the DBA (di-n-butylamine) adsorption amount of silica is, for example, preferably 20 to 100 mmol/kg. The DBA adsorption amount indicates the amount of DBA adsorbed to the hydroxyl groups on the silica surface, and is expressed as the number of mmoles of DBA adsorbed to 1 kg of silica.

The content of (E) the inorganic filler is preferably 10 to 90 parts by mass relative to 100 parts by mass of (A) the diene-based rubber from the viewpoint of achieving both resistance to vulcanization reversion and durability, more preferably 20 to 80 parts by mass, and even more preferably 40 to 70 parts by mass.

[Other components]

This vibration isolation rubber composition may optionally contain, in addition to components (A) to (E), a vulcanization accelerator, a vulcanization aid, an antioxidant, a process oil, a silane coupling agent, etc.

The vulcanization accelerator includes, for example, thiuram-based, guanidine-based, and thiazole-based vulcanization accelerators. These may be used alone or in combination of two or more.

The thiuram-based vulcanization accelerator includes, for example, tetramethylthiuram disulfide (TMTD), tetraethylthiuram disulfide (TETD), tetrabutylthiuram disulfide (TBTD), tetrakis (2-ethylhexyl) thiuram disulfide (TOT), tetrabenzylthiuram disulfide (TBzTD), etc. Among these, tetrabutylthiuram disulfide (TBTD) is preferred from the viewpoint of dispersibility. The content of the thiuram-based vulcanization accelerator is, for example, preferably 0.1 to 0.5 parts by mass, and more preferably 0.2 to 0.4 parts by mass, relative to 100 parts by mass of (A) the diene-based rubber.

In another embodiment of the disclosure, the vibration isolation rubber composition may contain substantially no thiuram-based vulcanization accelerator. For example, in applications where durability is relatively important (such as a suspension bush), the content of the thiuram-based vulcanization accelerator may be less than 0.1 part by mass, further less than 0.05 part by mass, and particularly 0 part by mass, relative to 100 parts by mass of (A) the diene-based rubber.

The guanidine-based vulcanization accelerator includes, for example, N,N′-diphenylthiourea, trimethylthiourea, N,N′-diethylthiourea, N,N′-dibutylthiourea, etc.

The thiazole-based vulcanization accelerator includes, for example, dibenzothiazyl disulfide (MBTS), 2-mercaptobenzothiazole (MBT), 2-mercaptobenzothiazole sodium salt (NaMBT), 2-mercaptobenzothiazole zinc salt (ZnMBT), etc.

The vulcanization aid includes, for example, zinc oxide (ZnO), stearic acid, magnesium oxide, etc. These may be used alone or in combination of two or more. The content of the vulcanization aid is, for example, preferably 0.1 to 10 parts by mass relative to 100 parts by mass of (A) the diene-based rubber, more preferably 0.3 to 8 parts by mass, and even more preferably 1 to 6 parts by mass.

The antioxidant includes, for example, a carbamate-based antioxidant, a phenylenediamine-based antioxidant, a phenol-based antioxidant, a diphenylamine-based antioxidant, a quinoline-based antioxidant, an imidazole-based antioxidant, waxes, etc. These may be used alone or in combination of two or more. The content of the antioxidant is, for example, preferably 0.3 to 15 parts by mass relative to 100 parts by mass of (A) the diene-based rubber, more preferably 0.5 to 10 parts by mass, and particularly preferably 1 to 8 parts by mass.

The process oil includes, for example, a naphthenic oil, a paraffinic oil, an aromatic oil, etc. These may be used alone or in combination of two or more. The content of the process oil is, for example, preferably 1 to 30 parts by mass relative to 100 parts by mass of (A) the diene-based rubber, more preferably 2 to 20 parts by mass, and even more preferably 3 to 15 parts by mass.

The silane coupling agent includes, for example, a mercapto-based silane coupling agent, a sulfide-based silane coupling agent, an amine-based silane coupling agent, an epoxy-based silane coupling agent, a vinyl-based silane coupling agent, etc. These may be used alone or in combination of two or more. The content of the silane coupling agent is, for example, preferably 0.1 to 10 parts by mass relative to 100 parts by mass of (A) the diene-based rubber, and more preferably 0.3 to 8 parts by mass.

### [Method of Preparing Vibration Isolation Rubber Composition and Method of Producing Vibration Isolation Rubber Member]

This vibration isolation rubber composition can be prepared by using components (A) to (E) in specific ratios and further using the other components described above as necessary, and kneading these with a kneading machine such as a kneader, a Banbury mixer, an open roll, a twin-screw mixer or the like. In addition, this vibration isolation rubber composition can be turned into a vibration isolation rubber member (vulcanizate) by, for example, vulcanizing the composition at a high temperature (150 to 170° C.) for 5 to 30 minutes.

### [Uses of Vibration Isolation Rubber Member]

The vibration isolation rubber member made of a vulcanizate of this vibration isolation rubber composition can suppress a decrease in durability while improving resistance to vulcanization reversion, and therefore can exhibit excellent performance as a material for vibration isolation rubber. For example, the vibration isolation rubber member can be suitably used as a component part such as an engine mount, a stabilizer bush, a suspension bush, a motor mount, and a subframe mount used in vehicles such as automobiles (also including electric vehicles (EV), fuel cell vehicles (FCV), plug-in hybrid vehicles (PHV), and hybrid vehicles (HV)).

The vibration isolation rubber member can also be used as seismic control (vibration control) devices and seismic isolation devices such as a vibration damper for computer hard disks, a vibration damper for general home appliances such as washing machines, a vibration-damping wall for architecture in the construction and housing fields, and a seismic control (vibration control) damper.

### EXAMPLES

Examples and Comparative Examples of the disclosure will be described. However, the disclosure is not limited to these examples. First, the following raw materials were prepared.

### [Natural Rubber (NR)]

### [Bismaleimide Compound]

Sumifine BM produced by Sumika Chemtex Company, Limited
(N,N′-m-phenylene bismaleimide)

### [Sulfenamide-Based Vulcanization Accelerator]

Sulfenamide-based vulcanization accelerator ACCCEL CZ produced by Kawaguchi Chemical Industry Co., Ltd.
(N-cyclohexyl-2-benzothiazolyl sulfenamide)

### [Sulfur-Based Vulcanizing Agent]

Sulfur produced by Karuizawa Smelter

### [Inorganic Filler]

SEAST SO produced by Tokai Carbon Co., Ltd.
(FEF grade carbon black, BET specific surface area 42 m²/g, DBP oil absorption amount: 115 mL/100 g, iodine adsorption amount: 44 mg/g)

### [Zinc Oxide]

Zinc oxide type 2 produced by Sakai Chemical Industry Co., Ltd.

### [Stearic Acid]

Beads Stearic Acid Sakura produced by NOF Corporation

### [Antioxidant]

Antigen 6C produced by Sumitomo Chemical Co., Ltd.

### [Process Oil]

Sansen 410 produced by Japan Sun Oil Company, Ltd.

### Examples 1 to 9, Comparative Examples 1 to 6

Next, the raw materials were mixed in the ratios shown in Table 1 and kneaded to prepare vibration isolation rubber compositions. The kneading was carried out by kneading the raw materials other than the sulfur-based vulcanizing agent and the sulfenamide-based vulcanization accelerator at 140° C. for 5 minutes using a Banbury mixer, and then adding the sulfur-based vulcanizing agent and the sulfenamide-based vulcanization accelerator and kneading at 60° C. for 5 minutes using an open roll.

With use of the vibration isolation rubber compositions of the Examples and Comparative Examples obtained above, the properties were evaluated according to the following criteria.

### <Evaluation Test for Resistance to Vulcanization Reversion>

Each vibration isolation rubber composition was subjected to a vulcanization test using a vibration vulcanization tester (rheometer tester) at 170° C., the maximum elastic torque (MH) and the torque (ML) 30 seconds to 5 minutes after the maximum elastic torque (MH) was reached were measured, and the vulcanization reversion rate (%) was calculated according to the following formula.

$$( Formula ) Vulcanization reversion rate ( \% ) = [ ( M H - M L ) / M H ] \times 100$$

The vulcanization reversion rate (%) in each of the Examples and Comparative Examples was calculated as an index conversion value when the vulcanization reversion rate (%) in Example 1 was set to 100, and was evaluated according to the following criteria. The results are shown in Table 1.

### [Evaluation Criteria]

⊚ (excellent): 100 or less
◯ (very good): over 100 and 110 or less
x (poor): over 110

### <Evaluation Test for Durability>

Each vibration isolation rubber composition was press-molded (vulcanized) under conditions of 150° C.×20 minutes to prepare a rubber sheet having a thickness of 2 mm. A JIS No. 3 dumbbell was punched out from this rubber sheet, and a dumbbell fatigue test (extension test) was carried out using the dumbbell in accordance with JIS K6260 to measure the number of extensions 5 at break (number of times to break).

The number of times to break in each of the Examples and Comparative Examples was calculated as an index conversion value when the number of times to break in Example 1 was set to 100, and was evaluated according to the following criteria. The results are shown in Table 1.

### [Evaluation Criteria]

⊚ (excellent): 100 or more
◯ (very good): 75 or more and less than 100
x (poor): less than 75

TABLE 1
parts by mass

| | | Example | | | | | | | |
|---|---|---|---|---|---|---|---|---|---|
| | | 1 | 2 | 3 | 4 | 6 | 7 | 8 | 9 |
| Compound | Natural | 100 | 100 | 100 | 100 | 100 | 100 | 100 | 100 |
| to be | rubber | | | | | | | | |
| mixed | (NR) | | | | | | | | |
| | Zinc oxide | 3 | 3 | 3 | 3 | 3 | 3 | 3 | 3 |
| | Stearic acid | 3 | 3 | 3 | 3 | 3 | 3 | 3 | 3 |
| | Antioxidant | 2 | 2 | 2 | 2 | 2 | 2 | 2 | 2 |
| | Carbon black | 50 | 50 | 50 | 50 | 50 | 50 | 50 | 50 |
| | Process oil | 5 | 5 | 5 | 5 | 5 | 5 | 5 | 5 |
| | Sulfur-based | 1.5 | 3 | 3 | 3 | 1.5 | 0.35 | 5 | 2 |
| | vulcanizing | | | | | | | | |
| | agent | | | | | | | | |
| | Bismaleimide | 3.5 | 2.5 | 2.5 | 1 | 5 | 4 | 1 | 0.8 |
| | compound | | | | | | | | |
| | Sulfenamide- | 2 | 0.5 | 3 | 2 | 1.5 | 0.5 | 2 | 1 |
| | based | | | | | | | | |
| | vulcanization | | | | | | | | |
| | accelerator | | | | | | | | |
| Mass ratio (C/D) of | | 1.33 | 0.17 | 1.00 | 0.67 | 1.00 | 1.43 | 0.40 | 0.50 |
| sulfenamide-based | | | | | | | | | |
| vulcanization | | | | | | | | | |
| accelerator/sulfur- | | | | | | | | | |
| based vulcanizing | | | | | | | | | |
| agent | | | | | | | | | |
| Evaluation | Vulcanization | 100 | 81 | 88 | 92 | 94 | 110 | 77 | 103 |
| | reversion rate | ⊚ | ⊚ | ⊚ | ⊚ | ⊚ | ◯ | ⊚ | ◯ |
| | (index | | | | | | | | |
| | conversion | | | | | | | | |
| | value) | | | | | | | | |
| | Durability | 100 | 76 | 96 | 109 | 80 | 83 | 75 | 111 |
| | (index | ⊚ | ◯ | ◯ | ⊚ | ◯ | ◯ | ◯ | ⊚ |
| | conversion | | | | | | | | |
| | value) | | | | | | | | |

parts by mass

| | | Comparative Example | | | | | |
|---|---|---|---|---|---|---|---|
| | | 1 | 2 | 3 | 4 | 5 | 6 |
| Compound | Natural | 100 | 100 | 100 | 100 | 100 | 100 |
| to be | rubber | | | | | | |
| mixed | (NR) | | | | | | |
| | Zinc oxide | 3 | 3 | 3 | 3 | 3 | 3 |
| | Stearic acid | 3 | 3 | 3 | 3 | 3 | 3 |
| | Antioxidant | 2 | 2 | 2 | 2 | 2 | 2 |
| | Carbon black | 50 | 50 | 50 | 50 | 50 | 50 |
| | Process oil | 5 | 5 | 5 | 5 | 5 | 5 |
| | Sulfur-based | 2.5 | 1.5 | 1.5 | 3 | 0.2 | 6 |
| | vulcanizing | | | | | | |
| | agent | | | | | | |
| | Bismaleimide | 3.5 | 2.5 | 0.5 | 6 | 3.5 | 2.5 |
| | compound | | | | | | |
| | Sulfenamide- | 0.4 | 4 | 1 | 1 | 1 | 1 |
| | based | | | | | | |
| | vulcanization | | | | | | |
| | accelerator | | | | | | |
| Mass ratio (C/D) of | | 0.16 | 2.67 | 0.67 | 0.33 | 5.00 | 0.17 |
| sulfenamide-based | | | | | | | |
| vulcanization | | | | | | | |
| accelerator/sulfur- | | | | | | | |
| based vulcanizing | | | | | | | |
| agent | | | | | | | |
| Evaluation | Vulcanization | 83 | 111 | 112 | 75 | 117 | 66 |
| | reversion rate | ⊚ | X | X | ⊚ | X | ⊚ |
| | (index | | | | | | |
| | conversion | | | | | | |
| | value) | | | | | | |
| | Durability | 71 | 103 | 120 | 55 | 98 | 43 |
| | (index | X | ⊚ | ⊚ | X | ◯ | X |
| | conversion | | | | | | |
| | value) | | | | | | |

From the results in Table 1, it was confirmed that the vibration isolation rubber compositions and vulcanizates of the Examples of the disclosure were excellent in both resistance to vulcanization reversion and durability. That is, it was confirmed that the disclosure can suppress a decrease in durability while suppressing vulcanization reversion.

In contrast, it was confirmed that the Comparative Examples not satisfying the requirements of the disclosure had insufficient resistance to vulcanization reversion or durability.

In the above-mentioned Examples, specific embodiments of the disclosure are shown, but the above-mentioned Examples are merely illustrative and should not be interpreted as being limiting. Various modifications apparent to those skilled in the art are considered as being within the scope of the disclosure.

### INDUSTRIAL APPLICABILITY

The vibration isolation rubber member made of a vulcanizate of this vibration isolation rubber composition can suppress a decrease in durability while improving resistance to vulcanization reversion, and therefore can exhibit excellent performance as a material for vibration isolation rubber. For example, the vibration isolation rubber member can be used as a component part such as an engine mount, a stabilizer bush, a suspension bush, a motor mount, and a subframe mount used in vehicles such as automobiles.

What is claimed is:

1. A vibration isolation rubber composition, comprising the following components (A) to (E) and being characterized in that, relative to 100 parts by mass of the component (A), a content of the component (B) is 0.6 to 5.5 parts by mass, a content of the component (C) is 1.5 to 3.5 parts by mass, a content of the component (D) is 0.25 to 5.5 parts by mass, a mass ratio [(C)/(D)] of the component (C) to the component (D) is 0.15 to 5.0, and a mass ratio [(B)/(C)] of the component
(B) to the component (C) is 0.4 to 5.5.
(A) diene-based rubber
(B) bismaleimide compound
(C) sulfenamide-based vulcanization accelerator
(D) sulfur-based vulcanizing agent
(E) inorganic filler

2. The vibration isolation rubber composition according to claim 1, wherein the (D) sulfur-based vulcanizing agent has a content of 0.5 to 5.5 parts by mass.

3. The vibration isolation rubber composition according to claim 1, wherein the mass ratio [(C)/(D)] of the (C) sulfenamide-based vulcanization accelerator to the (D) sulfur-based vulcanizing agent is 0.15 to 1.35.

4. The vibration isolation rubber composition according to claim 1, wherein the mass ratio [(B)/(C)] of the (B) bismaleimide compound to the (C) sulfenamide-based vulcanization accelerator is 0.5 to 5.5.

5. The vibration isolation rubber composition according to claim 1, comprising N,N′-m-phenylene bismaleimide as the (B) bismaleimide compound.

6. The vibration isolation rubber composition according to claim 1, comprising at least one selected from a group consisting of N-cyclohexyl-2-benzothiazolyl sulfenamide and N-oxydiethylene-2-benzothiazolyl sulfenamide, as the (C) sulfenamide-based vulcanization accelerator.

7. The vibration isolation rubber composition according to claim 1, comprising at least one selected from a group consisting of carbon black and silica, as the (E) inorganic filler.

8. The vibration isolation rubber composition according to claim 1, comprising carbon black having a BET specific surface area of 10 to 150 m²/g, as the (E) inorganic filler.

9. The vibration isolation rubber composition according to claim 1, comprising carbon black having an iodine adsorption amount of 10 to 150 mg/g, as the (E) inorganic filler.

10. The vibration isolation rubber composition according to claim 1, further comprising a thiuram-based vulcanization accelerator.

11. A vibration isolation rubber member, comprising a vulcanizate of the vibration isolation rubber composition according to claim 1.

12. The vibration isolation rubber member according to claim 11, being a vibration isolation rubber member for a vehicle.

13. The vibration isolation rubber member according to claim 12, being a vibration isolation rubber member for a component part of an engine mount, a stabilizer bush, or a suspension bush.
